(19) United States
(12) Patent Application Publication
(10) Pub. No.: US 2026/0213867 A1
(43) Pub. Date: Jul. 23, 2026

(54) Programmable Wavelength-Selective Splitter

(71) Applicant: TELEFONAKTIEBOLAGET LM ERICSSON (PUBL), Stockholm (SE)

(72) Inventors: Alfredo Palagi, Genova (IT); Paola Iovanna, Pisa (IT); Luca Giorgi, Pisa (IT)

(21) Appl. No.: 19/106,271

(22) PCT Filed: Sep. 9, 2022
(86) PCT No.: PCT/EP2022/075153

§ 371 Date: Feb. 25, 2025

(51) Int. Cl. H04J 14/02

(52) U.S. Cl. CPC H04J 14/0272; H04J 14/0257

(57) ABSTRACT

A method performed by a remote node comprising a programmable wavelength-selective splitter, PWSS. The method comprises receiving (901), from a central control node, a first optical signal comprising configuration information; and configuring (902) the PWSS to direct one or more wavelengths of an incoming wavelength-division multiplexed optical signal towards a corresponding one or more ports of a plurality of ports comprised in the PWSS based on the configuration information. The present application also relates to a remote node comprising a PWSS, a method in a central control node, and a central control node.

### TECHNICAL FIELD

Embodiments described herein relate to a remote node comprising a programmable wavelength-selective splitter, a method performed by a remote node comprising a programmable wavelength-selective splitter, a central control node and a method performed by a central control node.

### BACKGROUND

The evolution of fifth generation (5G) towards 5G-Beyond and sixth generation (6G) has further enforced the need for dense wavelength-division multiplexing (DWDM) technology to help meet the increasingly high bandwidth and low latency requirements.

Network tunability is also increasingly desirable for several reasons. Firstly, to reduce the cost of inventory; secondly, to simplify operation in field, both during the configuration phase and during fault recovery; thirdly, to support network planning, and fourthly, to support on-the-fly reconfigurability.

Cloud Radio Access Network (RAN) (also referred to as Centralized RAN) benefits from the use of DWDM technology in the access segment to connect several antenna sites to a centralized site (typically the central office of the operators) with scalable bandwidth. In this case, different network topologies can be used to connect the antenna sites to the central site (e.g., chain, point-to-point or tree topologies). FIG. 1 is a schematic showing three nodes (site-1, site-2 and site-3) in chain topology.

In some cases, DWDM technology can be used to overlay RAN on already-installed passive optical network (PON) infrastructure, and this enables the use of a widely deployed fibre infrastructure. FIG. 2 is a schematic showing the use of DWDM over PON.

Such network scenarios can be based on fixed transceivers (TRX) with cabled wavelength. The fixed nature of these TRXs impacts the inventory requirements because it is necessary to store several TRXs at each site, one for each wavelength. Moreover, operations and changes to the network (e.g., configuration and/or fault recovery) cannot be performed as simple plug and play of modules because it is necessary to connect the correct wavelength to the correct TRX. Thus, fixed filters and transceivers require rigid wavelength planning from day one and it is not possible to make changes to the wavelength planning without complex hardware changes.

To simplify inventory and operations, TRXs that are tuneable in transmission (e.g., using tuneable lasers) have been realised. Such TRXs do not have tuneable receivers, and therefore they are used in combination with multiplexers (MUXs) in the networks that can select a specific wavelength to direct to each port (known as “coloured” networks) and enables the correct wavelength to be sent to the receivers. The assignment of the wavelengths must be performed in advance (e.g., in a planning phase) for the network and the antenna sites. Such tuneable TRXs make use of algorithms for self-tuning that enable automatic procedures to be used for configuration, thereby simplifying the configuration.

### SUMMARY

It is an object of the present disclosure to provide methods and devices which at least partially address one or more of the challenges discussed above. In particular, it is an object of the present disclosure to provide techniques for realising a wavelength-selective splitter module that can be dynamically configured in both the transmission and receiver directions. It is a further object of the present disclosure to provide techniques for dynamic configuration and control of the wavelength-selective splitter module. These techniques are particularly beneficial when the module does not have access to the Data Control Network (DCN) or Network Management system (NMS), e.g., at a remote site.

The present disclosure provides a method performed by a remote node comprising a programmable wavelength-selective splitter (PWSS). The method comprises receiving, from a central control node, a first optical signal comprising configuration information. The method further comprises configuring the PWSS to direct one or more wavelengths of an incoming wavelength-division multiplexed (WDM) optical signal towards a corresponding one or more ports of a plurality of ports comprised in the PWSS based on the configuration information.

The present disclosure also provides a method performed by a central control node. The method comprises transmitting, to a remote node, a first optical signal comprising configuration information for configuring a PWSS comprised in the remote network node to direct one or more wavelengths of an incoming WDM optical signal towards a corresponding one or more ports.

The present disclosure also provides a remote node comprising a PWSS. The remote node further comprises a processor and a memory, the memory containing instructions executable by the processor. The remote node is configured to receive, from a central control node, a first optical signal comprising configuration information. The remote node is further configured to configure the PWSS to direct one or more wavelengths of an incoming WDM optical signal towards a corresponding one or more ports of a plurality of ports comprised in the PWSS based on the configuration information.

The present disclosure also provides a central control node. The central control node comprises a processor and a memory, the memory containing instructions executable by the processor. The central control node is configured to transmit, to a remote node, a first optical signal comprising configuration information for configuring a PWSS comprised in the remote node to direct one or more wavelengths of an incoming WDM optical signal towards a corresponding one or more ports of a plurality of ports comprised in the PWSS.

### BRIEF DESCRIPTION OF DRAWINGS

The present disclosure is described, by way of example only, with reference to the following figures, in which:—

FIG. 1 is a schematic diagram showing three nodes in chain topology;

FIG. 2 is a schematic diagram showing the use of DWDM over PON;

FIG. 3 is a schematic diagram of a device according to some embodiments;

FIG. 4 is a schematic diagram of a device according to some embodiments;

FIG. 5 is a schematic diagram showing an example control frame structure;

FIG. 6 is a flow chart showing a method in a central control node according to some embodiments;

FIG. 7 is a flow chart showing a method in a remote node comprising a PWSS according to some embodiments;

FIG. 8a is a flow chart showing a method in a central control node according to some embodiments;

FIG. 8b is a flow chart showing a method in a remote node comprising a PWSS according to some embodiments;

FIG. 9 is a flow chart showing a method performed by a remote node comprising a PWSS according to some embodiments;

FIG. 10 is a flow chart showing a method performed by a central control node according to some embodiments;

FIG. 11 is a block diagram illustrating functional modules in a remote node comprising a PWSS according to some embodiments;

FIG. 12 is a block diagram illustrating functional modules in a remote node comprising a PWSS according to some embodiments;

FIG. 13 is a block diagram illustrating functional modules in a central control node according to some embodiments; and

FIG. 14 is a block diagram illustrating functional modules in a central control node according to some embodiments.

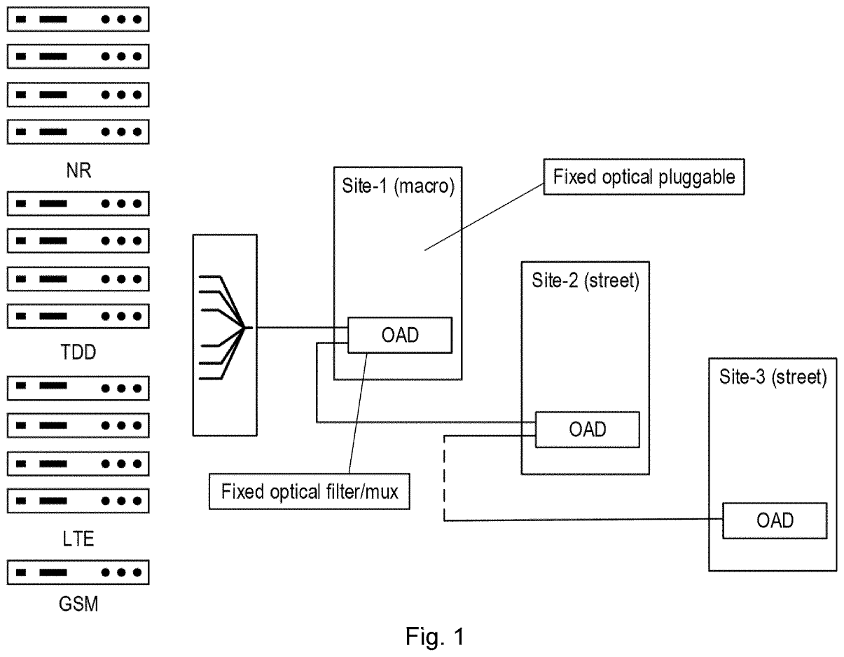

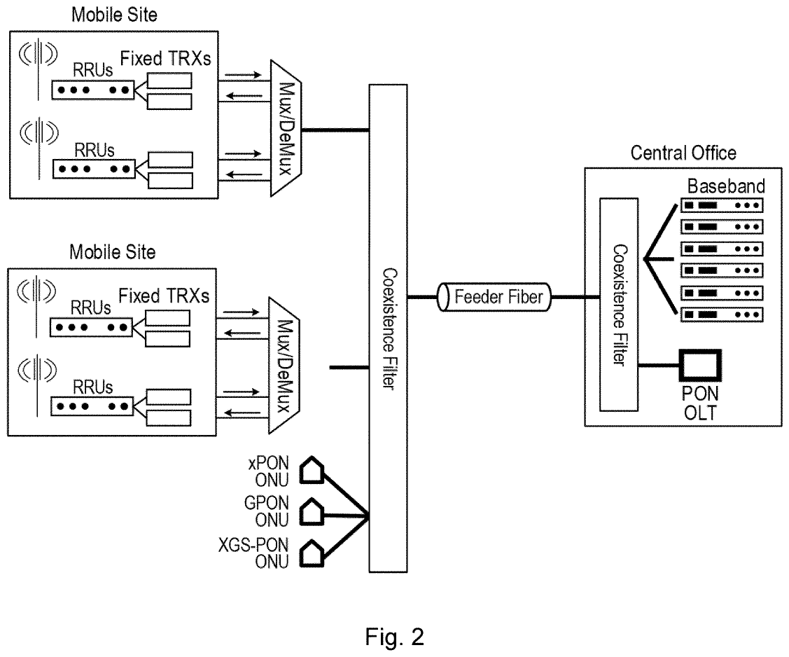

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

As used herein, a central control node is a node located at a central office of a network. The central control node may be central for data traffic in the network. The central control node may be responsible for controlling remote nodes in the network. A central control node may also be referred to as a centralised site or central system.

As used herein, a remote node is a node located away from a central office of a network. For example, the remote node may be at an antenna site or at a remote radio unit equipment site. Depending on the radio architecture (monolithic or split), the antenna site may be composed of the remote radio unit equipment and antenna, or a monolithic radio base station and antenna. Herein, Radio Access Network (RAN) is used as a reference scenario. The site of the remote node may also be referred to herein as a cell site, an antenna site, remote radio unit equipment, a base station, or a base station site.

Herein, when a WDM signal is referred to as comprising a plurality of wavelengths, it is to be understood that each of the plurality of wavelengths may in fact comprise a band of wavelengths. Each of the plurality of wavelengths may be a central wavelength of a band of wavelengths. Therefore, it is to be understood that each wavelength may have an associated bandwidth. Thus, a wavelength may refer to a band of wavelengths. A wavelength (e.g., a band of wavelengths) may also be referred to herein as a wavelength channel or a frequency channel. The associated bandwidth may depend on: (i) the information data rate assigned to the wavelength; and (ii) the modulation technique. Some examples of associated bandwidths are as follows. For an information data rate of 10 Gb/s and on-off keying (OOK) modulation technique, the bandwidth is 14 GHz. For an information data rate of 25 Gb/s and OOK modulation technique, the bandwidth is 35 GHz. For an information data rate of 50 Gb/s and Pulse Amplitude Modulation 4-level (PAM 4 ) modulation technique, the bandwidth is 35 GHz. International Telecommunications Union-Telecommunications Sector (ITU-T) G.694.1 provides information about wavelength/frequency grids and channel spacings for DWDM applications.

Throughout this specification, ‘PWSS’ may be used interchangeably with ‘PWSS module’ and ‘PWSS device’. The term ‘module’ may also be used to refer to components comprised in a remote node or in a PWSS.

As noted above, TRXs that are tuneable in transmission (e.g., using tuneable lasers) have been realised to simplify inventory and operations. TRXs in which both the receiver and the transmitter are fully tuneable (referred to herein as fully tuneable TRXs) would provide further benefits. For example, a fully tuneable TRX could operate as a plug and play module and would dispense with the need to plan the wavelengths in advance. This would simplify operations on the optical network significantly. Studies are in development to realise fully tuneable filters in the receiver direction.

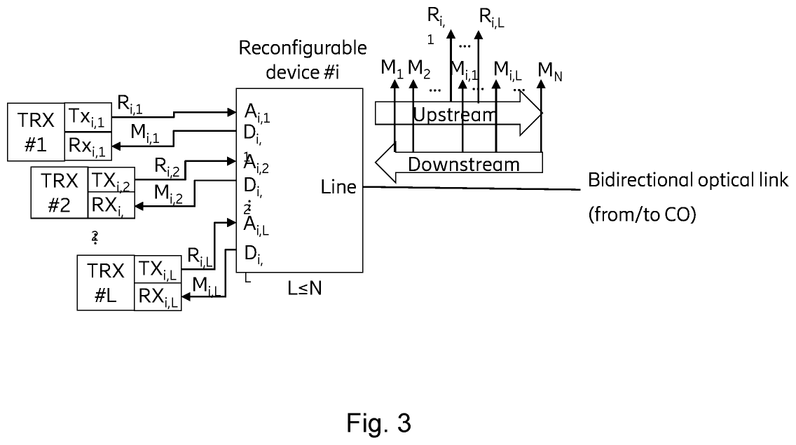

FIG. 3 shows a reconfigurable device in accordance with some embodiments. The reconfigurable device is a wavelength-selective splitter and may be comprised in a node, e.g., in a remote node at a remote site. The reconfigurable device is labelled, i.

The reconfigurable device receives an incoming downstream WDM optical signal comprising N wavelengths (or bands of wavelengths) and passes the signal through a demultiplexer comprised in the reconfigurable device to produce N signals of different wavelengths (or bands of wavelengths).

The reconfigurable device further comprises a plurality of tuneable filter ports, also referred to herein as add/drop ports, cabled ports or transceiver ports. Each add/drop port pair in the reconfigurable device is connected to a transceiver, TRX₁ to TRX_{L}. In FIG. 3, there are L drop ports labelled D_{i,1} to D_{i,L}, where L≤N. These drop ports are used to drop a subset of up to L wavelengths from the incoming downstream comb. These L dropped wavelengths are sent to L local receivers RX_{i,1} to RX_{i,L}. In FIG. 3, there are also L add ports labelled A_{i,1} to A_{i,L}. These add ports are used to add a subset of up to L new wavelengths. These L new wavelengths are added by L local transmitters, TX_{i,1} to TX_{i,L}, and are sent in the outgoing upstream comb. The data transmitted on these new wavelengths may be locally generated at the site of the reconfigurable device.

The reconfigurable device further comprises a multiplexer to combine the outgoing wavelengths (or wavelength bands) in an upstream WDM optical signal. In FIG. 3, the outgoing upstream WDM optical signal comprises the L new wavelengths R_{i,1} to R_{i,L}. The downstream and upstream WDM optical signals may be transmitted on a bidirectional optical link.

The reconfigurable device of FIG. 3 may typically be located at an antenna (remote) site. Alternatively, the reconfigurable device may be located at the central office of the network, or at both the remote site and the central office.

The techniques described herein recognise that, when a device such as the device shown in FIG. 3 is located at a remote site, it may not have access to the DCN and through it to NMS. It is therefore necessary to define a method to configure and control the device dynamically and remotely. Solutions with these properties do not yet exist.

According to the techniques described herein, the configuration and/or control of a device such as the device shown in FIG. 3 may be performed using the same wavelengths that are used to carry traffic. The configuration and control of the device may be in full compliance with existing TRXs that are tuneable in transmission. This ensures interworking with existing technology. According to some embodiments of the present disclosure, there is provided a plug and play Programmable Wavelength-Selective Splitter and a related method for configuration and/or operational tasks. In some embodiments, the PWSS is comprised in a remote node.

The PWSS can be configured to select, in a programmable manner, the specific wavelength(s) for each port as add/drop. The selected wavelength can differ for each add/drop port pair. The method for configuration and control allows each pair of add and drop ports to be tuned on the desired wavelengths. The PWSS may also be configured to transmit some wavelengths without being directed to add/drop ports. Thus, the data on these wavelengths are unmodified by the PWSS.

During configuration of the PWSS, the wavelength selective paths are setup using multiplexer/demultiplexer (mux/demux) filters and optical add-drop multiplexers (OADMs), as they would be in conventional DWDM networks. An example of this type of configuration was described with reference to FIG. 3.

According to the present disclosure, the configuration information is transmitted from the network management system to the remote node comprising the PWSS using envelope modulation of an optical signal.

After the PWSS is switched on, the PWSS (or, in some embodiments, the remote node in which the PWSS is comprised) looks for the optical channel comprising the control information and/or configuration information for the PWSS. For example, the remote node may scan all the possible downstream wavelengths. When the relevant channel is identified, the scanning stops, and the PWSS (or remote node) detects the configuration information for each add and drop port.

At the end of the configuration step, the wavelength selective paths managed by the PWSS/remote node are ready for normal operation and the remote transceivers (e.g., TX_{i,1} to TX_{i,L} in FIG. 3) can start the negotiation with the central office to setup the data channels. The remote transceivers may be comprised in the remote node that comprises the PWSS.

The PWSS disclosed herein is thus able to drop a subset of wavelengths received from the incoming downstream DWDM comb, and to add a subset of wavelengths to the upstream DWDM comb transmitted by the PWSS. This allows data to be removed and/or added at the remote node. The PWSS may interwork with existing pluggable tuneable TRXs and may be compatible with networks that are not coloured (e.g., networks based on passive elements such splitters that do not require fixed wavelength planning). Moreover, the PWSS and related methods can also provide a network with the capability to handle fully tuneable data channels in both uplink and downlink directions.

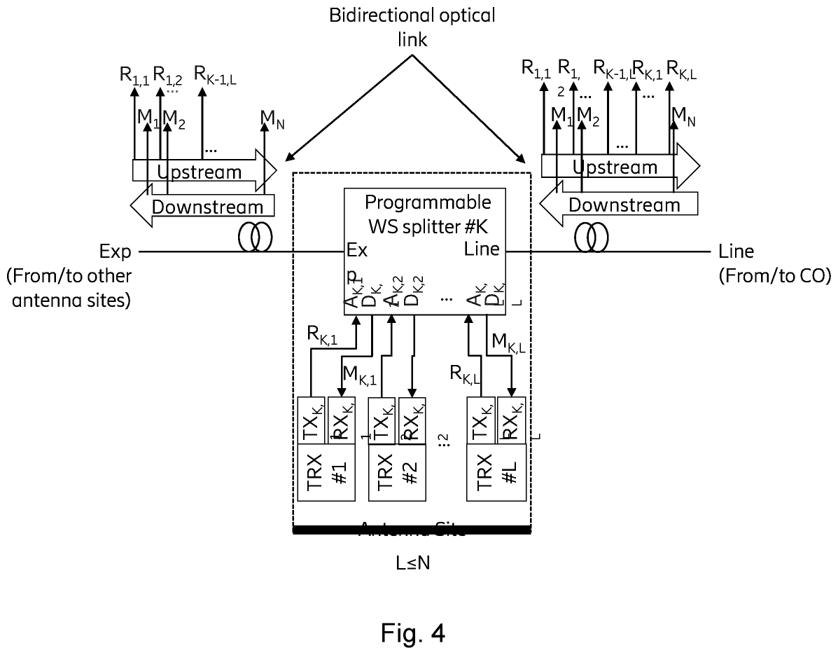

FIG. 4 depicts a PWSS at an antenna site in accordance with some embodiments. The PWSS, labelled K, comprises two bidirectional ports: the Line port and the Exp port. These are used for the transmission of aggregated upstream and downstream optical signals. The PWSS also comprises 2L ports dedicated for add/drop channels (e.g., L pairs in which each pair comprises an add port and a drop port, as shown in FIG. 4). The L add ports are labelled A_{K,1} to A_{K,L} and the drop ports are labelled D_{K,1} to D_{K,L}. Each add/drop port is connected to a transceiver, TRX₁ to TRX_{L}. The PWSS may be comprised in a remote node and the transceivers may optionally be comprised in the same remote node.

FIG. 4 shows an incoming downstream WDM optical signal comprising N wavelengths (or wavelength bands), where L≤N. The ingress comb of wavelengths enters the module at the Line port, and then a subset of up to L wavelengths can be dropped at respective ports and sent to corresponding transceivers. According to the internal design of the PWSS, the comb that exits the module from port Exp could include all the wavelengths that entered the PWSS including the dropped ones (i.e., all N wavelengths as shown in FIG. 4), or just the wavelengths without the dropped ones (i.e., N−L, not shown in FIG. 4).

In the opposite direction, a subset of up to L wavelengths is added at the module. In FIG. 4, the incoming upstream WDM signal comprises wavelengths from other antenna sites labelled 1 to K−1. At the PWSS (labelled K), additional wavelengths (or wavelength bands) R_{K,1} to R_{K,L} are added at add ports A_{K,1} to A_{K,L} respectively. These additional wavelengths, from the assigned transmitters TX_{K,1} to TX_{K,L}, can be multiplexed and added to the incoming upstream comb received at the Exp port and sent out from the Line port toward the central office of the network. The signal received at the Exp port may be arriving from PWSSs that are connected in chain, e.g., PWSS 1 to PWSS K−1.

In alternative embodiments, the incoming upstream WDM signal further comprises the L wavelengths R_{K,1} to R_{K,L} when it enters at the Exp port, and data are added to these wavelengths at the transceiver ports before being sent out from the Line port.

According to the internal design of the PWSS, part of the ingress wavelength comb entering the PWSS at the Line port may cross the PWSS and exit the PWSS by the Exp port without being directed to any drop ports. Similarly, part of the wavelength comb entering the PWSS at the Exp port may cross the PWSS and exit the PWSS by the Line port without being directed to any add ports. Thus, these wavelengths are transmitted unmodified.

According to some embodiments, a PWSS, such as the PWSS depicted in FIG. 4, may operate in a DWDM network with MUX, DEMUX and OADM filters that are commercially available.

In some embodiments, the PWSS (or remote node) may receive a broadcast control channel sent from the central office that comprises configuration information about the subset of wavelengths to be assigned to the PWSS. This configuration information is used to dynamically and remotely configure the PWSS, e.g., by configuring the add/drop ports of the PWSS. The configuration information may comprise a set of assigned add/drop wavelengths. As noted above, a wavelength here may be a central wavelength of a band of wavelengths. The set of wavelengths may be planned, assigned, and modified dynamically from a central control node located in the central office. The central control node could comprise a transport controller such as a software-defined networking (SDN) controller, a Transport NMS, a radio controller or a radio NMS. For the sake of simplicity, but without loss of generality, the central control node will be referred to in the following description of certain embodiments as an NMS. In some embodiments, the control messages comprising the information may be sent by using a dedicated wavelength. The dedicated wavelength may be selected dynamically according to the status of the network. The control messages may be sent by exploiting envelope modulation of the optical signal that is used for sending the control information on a traffic or control wavelength (discussed, for example, in ITU-T G.698.4 (03/2018) as cited above).

The PWSS (or the remote node comprising the PWSS) may comprise a low-rate optical receiver that enables the PWSS to receive and detect the relevant control information. The low-rate optical receiver may be a photodiode, transimpedance and limiting amplifier, or clock data recovery (CDR).

The configuration information sent to the PWSS may comprise an identifier that enables the PWSS (or a remote node comprising the PWSS) to recognise that the information is applicable to the PWSS. The identifier may be, for example, a serial number of the PWSS. The PWSS recognises to which PWSS in the network the communication is addressed by searching in the received stream destination addresses for its own pre-defined identifier (e.g., its serial number).

In some embodiments, the PWSS may look for a specified communication preamble. For example, the PWSS may need to distinguish broadcast configuration commands sent to it from messages sent to other PWSSs in the network, messages sent to/from tuneable receivers, and other remote Digital Diagnostics Monitoring Interface (DDMI) commands. This may be achieved by looking for a specified communication preamble.

The PWSS may configure the wavelengths on the add/drop ports based on the received configuration information. The PWSS may receive the commands to configure one or more communication channels. A communication channel may be a bidirectional channel comprising two signals, one travelling upstream and one travelling downstream. In some embodiments, the two signals in a bidirectional channel have the same wavelength. Herein, upstream refers to signals travelling toward a central office, and downstream refers to signals travelling away from a central office.

The corresponding add and drop wavelengths to be allocated to corresponding add and drop ports of the PWSS can be indicated in the control message on the control channel. In some embodiments, the PWSS receives in the control message only a subset of the information required to configure the PWSS ports. For example, the PWSS may receive only the add wavelengths, only the drop wavelengths, only the first channel, or only the identifier of a set of add/drop wavelengths. In these and other embodiments, the PWSS may derive the add/drop wavelength allocations using a local algorithm.

After the PWSS has been configured, the TRX is triggered to start the usual configuration/self-tuning procedures. The triggering of the TRX can be performed according to several alternative methods. For example, the system (e.g., the radio system, the Network Management Element, etc.) can perform a polling procedure to verify that the physical layer is configured and up. Alternatively, the system (e.g., the radio system, the Network Management Element, etc.) can receive a trigger/signal indicating that the transport network is configured. Alternatively, any method (self-tuning or tuning by remote) that is currently used for managing the link instauration may be used for triggering the TRX.

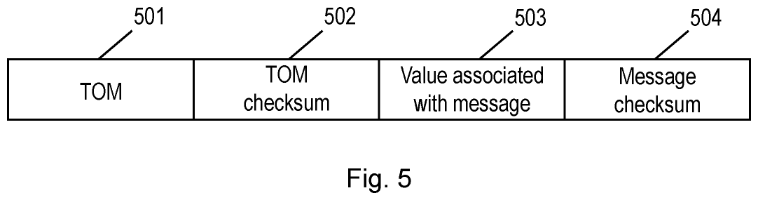

FIG. 5 depicts an example control frame structure for the control message in which the configuration information is sent according to certain embodiments. The control frame comprises four fields.

Firstly, the control frame comprises a Type of Message (TOM) 501. This is required because the same frame structure may be used in the network for remote DDMI commands. Thus, the TOM addresses the control frame to PWSS modules which distinguishes it from DDMI commands.

The control frame of FIG. 5 further comprises a checksum for the TOM 502.

The control frame of FIG. 5 further comprises the message content 503. This may comprise the commands sequence for the PWSS and will have a structure based on a list of information needed for the configuration. This could include one or more of: a PWSS identification, one or more port identifications, and one or more corresponding assigned wavelengths. A final word that finishes the PWSS programming is needed. For example, the final word could be the repetition of the PWSS identification code at the end of the message content.

The control frame of FIG. 5 further comprises a checksum for the message content 504.

The control channel may be selected by the central control node (e.g., NMS). The selected control channel may be, for example, a downstream wavelength that is not yet being used, or it could be a downstream wavelength that is being used.

As an example, a criterion for selection of the control channel could be selecting the “in traffic” downstream wavelength with the lowest ordinal number and using it for the control frame transmission and applying a low modulation index amplitude modulation to avoid traffic disruption.

The newly installed PWSS may detect the control channel by: (i) tuning a PWSS drop port (which is connected to the PWSS receiver) to the first ordinal downstream channel detected, and (ii) waiting to detect the control frame. The PWSS may wait for a predetermined period. Other mechanisms for detecting the control channel could be based on a blind tuning of a PWSS drop port (which is connected to the PWSS receiver). Alternatively, the PWSS may look for the control channel recognisable by the presence of a low modulation index amplitude modulation superimposed onto the main modulation. Alternatively, the PWSS may select a control channel from all channels used for broadcast transmission of the control frame that are always transmitted with the low modulation index amplitude modulation scheme and regardless of the available downstream signal.

Once the PWSS has detected the control frame with the configuration information, it configures/sets the PWSS ports accordingly. Once the ports have been configured, a new module of the coloured DWDM network is up and running as planned from the central control node. Negotiation with the remote transceivers (which are connected directly or indirectly to the add/drop ports of the PWSS) can begin.

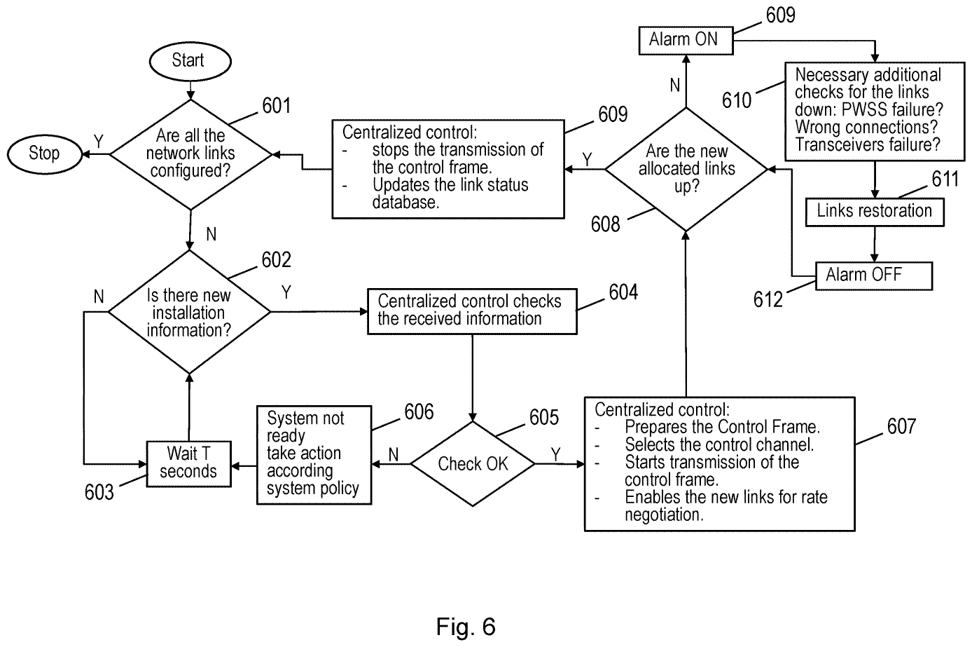

FIG. 6 is a flow chart showing a method in a central control node according to some embodiments. The central control node could be, for example, an NMS, SDN controller or transport controller. The flow chart shows a method for initial configuration of a remote PWSS. The method of FIG. 6 starts at step 601 with the central control node checking whether all the provisioned links of the network are configured. If the central control node determines that all network links are configured (Yes/Y), the method stops. If the central control node determines that all network links are not configured (No/N), it moves to step 602.

At step 602 the central control node considers whether there is new installation information relating to remote PWSSs. If there is not, the central control node waits for new installation information at step 603. The central control node may wait a fixed time period of T seconds. The time period may be a configurable parameter depending on the system in which the PWSS is included. For example, T could depend on the restart time of the radio equipment. As an alternative to step 603, the central control node may perform periodic polling, as described above.

When the central control node receives installation information indicating that a new PWSS has been installed (Y), the method of FIG. 6 proceeds to step 604. At step 604, the central control node checks the installation information for a notification containing the identification information of the PWSS/module (e.g., serial number and/or part number) and the indications about the cabled ports.

If the central control node determines, at step 605, that the information is not okay, e.g., the information is incomplete or the system is not able to take action based on the identification information, the method proceeds to step 606. At step 606, the central control node acts according to system policy. For example, the central control node may send a retransmission request, generate an alarm and/or wait for a further time period (e.g., at step 603).

If the central control node determines, at step 605, that the information is okay, the method will proceed to step 607. At step 607, the central control node checks the received information and prepares the control frame required for the PWSS configuration. The central control node then selects the control channel and starts the transmission of the control frame. The central control node then prepares the new links for rate negotiation.

At step 608, the central control node monitors to check whether the new allocated links are up. When all the new allocated links are up, the central control node, at step 613, stops the control frame transmission and releases the channel used for this purpose. The central control node also updates the link status database.

If the central control node determines at step 608 that the new allocated links are not all up (e.g., one or more is not up), it may raise an alarm at step 609 and perform necessary additional checks at step 610. For example, the central control node may check for one or more of: a failure in the PWSS, incorrect connections/cabling, and a failure of a transceiver(s). If the central control node determines at step 611 that the links have been restored, the alarm is turned off at step 612.

The method stops when all the provisioned network links have been configured.

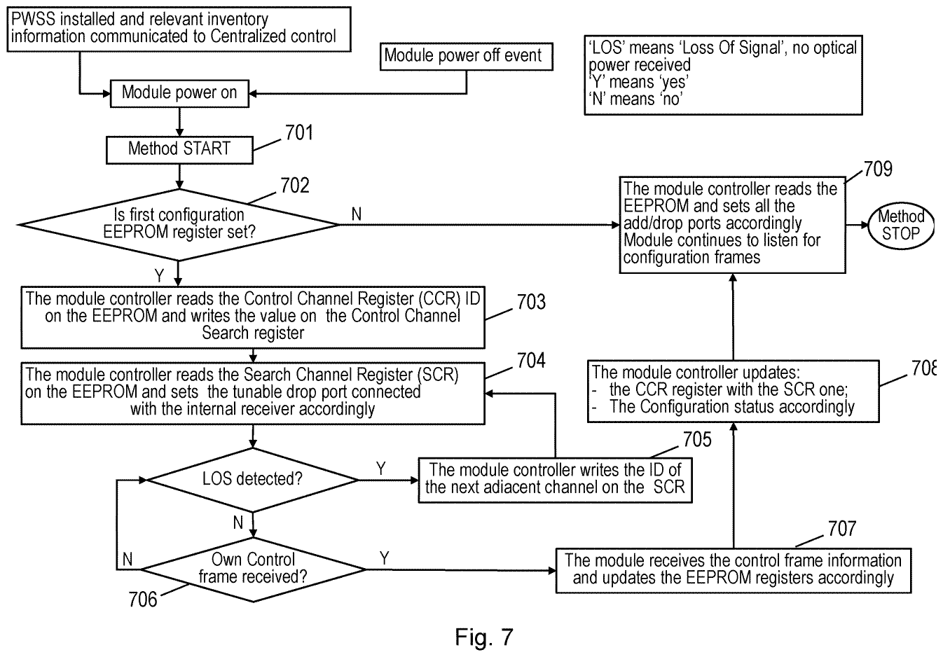

FIG. 7 is a flow chart showing a method in a remote node comprising a PWSS according to some embodiments. The PWSS may be referred to as a PWSS module comprising a module controller.

The method of FIG. 7 starts at step 701 when the module is powered on. The module may be powered on after the PWSS is installed and the relevant installation information is communicated to the NMS in the central office. The installation information may comprise inventory information such as serial number, part number, the number of cabled ports, etc. The module may alternatively be powered on after any event that has resulted in the module being powered off.

At step 702, the PWSS determines whether it has already been configured. If the electrically erasable programmable read-only memory (EEPROM) register is set to “first configuration” (Y), then it is the first configuration for the PWSS. For example, the EEPROM register may have a numerical value that indicates the “first configuration” status of the module. Thus, at step 703, the module controller looks for the control channel wavelength by reading the Control Channel Register (CCR) identifier on the EEPROM and writing the value on the control channel search register.

At step 704 of the FIG. 7 method, the module controller reads the Search Channel Register (SCR) on the EEPROM and sets the tuneable drop port connected with the internal receiver accordingly.

If loss of signal (LOS) is detected (i.e., no optical power is received), then the module controller, at step 705, writes the identifier of the next adjacent channel on the SCR and returns to step 704.

Once the PWSS controller has found the control channel wavelength, it waits for its own configuration information (step 706). For example, the configuration information may include an identifier for the PWSS.

Once the configuration information is obtained, the module, at step 707, receives the control frame information and updates the EEPROM registers accordingly.

At step 708, the module controller updates: (i) the CCR register with the SCR one; and (ii) the configuration status accordingly.

At step 709 of the FIG. 7 method, the module controller reads the EEPROM and configures/sets all the add/drop ports according to the information acquired. The module may also continue to look for configuration frames.

If, at step 702, the module controller determines that it is not the first configuration (e.g., the EEPROM register has a numerical value that is not equal to the “first configuration” value), then the PWSS controller configures the add/drop ports using the information stored in the EEPROM (step 709). The module may again continue to look for configuration frames.

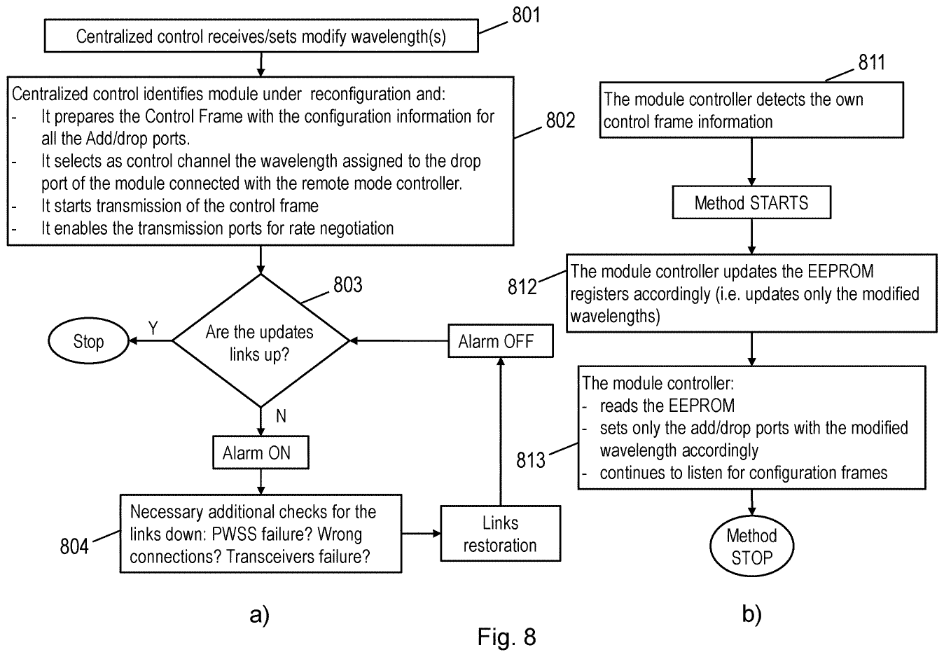

FIG. 8a is a flow chart showing a method in a central control node according to some embodiments. The method is for realising remote reconfiguration of a PWSS.

The reconfiguration starts at the central control node at step 801, where the centralized control receives or sets the reconfiguration of some wavelength(s) in the network.

At step 802, the central control node identifies the PWSS module under reconfiguration and prepares the Control Frame with the configuration information for all the add/drop ports of that PWSS module. The central control node then selects as control channel the wavelength assigned at the PWSS's drop port connected with the low-rate receivers. The central control node then starts the transmission of the control frame.

At step 803 of the FIG. 8a method, the central control node determines whether all the reconfigured links have gone up. If yes (Y), then the central control node stops the control frame transmission and releases the channel used for this purpose. If no (N) (e.g., one or only a subset of the new links has gone up), the central control node raises an alarm and performs additional checks at step 804. For example, the central control node may check for one or more of: a failure in the PWSS, incorrect connections/cabling, and a failure of a transceiver(s). When the links are restored, the alarm is switched off and the method returns to step 803.

The method ends when all updated links are up and the PWSS has been reconfigured.

FIG. 8b is a flow chart showing a method in a remote node comprising a PWSS according to some embodiments. The method is for realising remote reconfiguration of the PWSS. The PWSS may be referred to as a PWSS module.

At step 811 of the FIG. 8b method, the PWSS module detects its own control frame information received from the central control node and starts the method.

At step 812, the PWSS module controller updates the EEPROM registers according to the received control frame. The PWSS module may update the modified/changed wavelength(s) only.

At step 813, the PWSS module reads the EEPROM and reconfigures only the add/drop ports with a changed wavelength. The PWSS module will continue to listen for configuration information in its control frame.

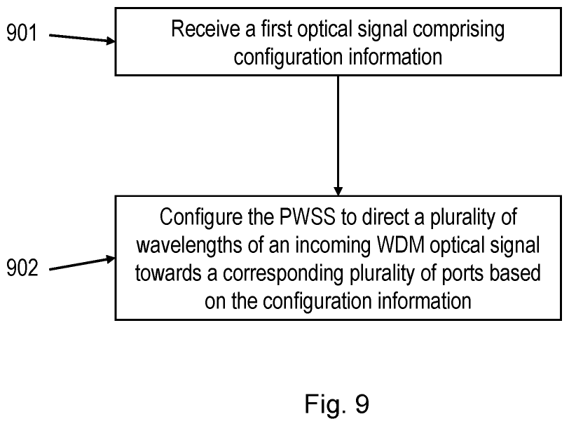

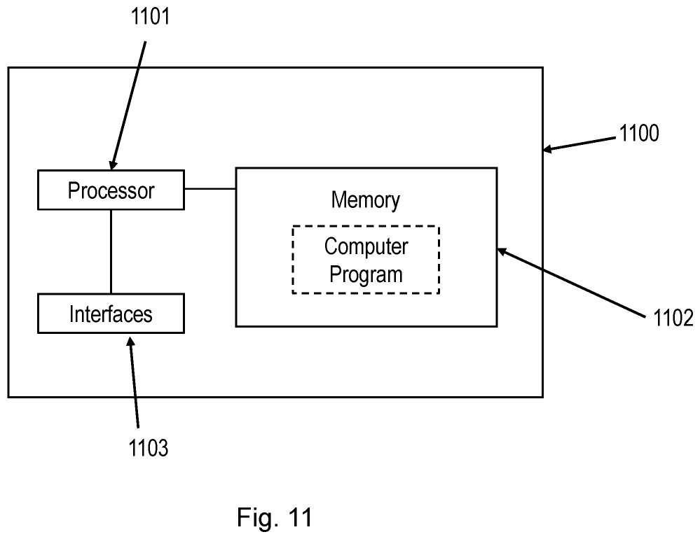

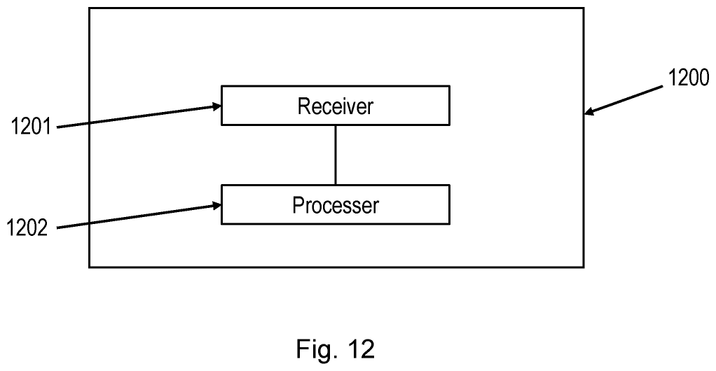

FIG. 9 is a flowchart showing a method performed by a remote node comprising a PWSS according to some embodiments. The remote nodes described with reference to FIGS. 11 and 12 may perform the method of FIG. 9.

In some embodiments, the remote node may be in chain topology, point-to-point topology or tree topology.

In step 901, the method of FIG. 9 comprises receiving, from a central control node, a first optical signal comprising configuration information. The receiving of the first optical signal may be performed, for example, by the receiver 1201 of remote node 1200.

The configuration information may be received: on a control channel; on a dedicated wavelength; and/or as an envelope modulation of the first optical signal. The configuration information may comprise one or more of: an identifier for the PWSS; an identifier for one or more of the one or more ports; and an identifier for one or more of the one or more wavelengths.

The method of FIG. 9 may further comprise a step of identifying a control channel comprising the configuration information. This step of identifying the control channel may be performed prior to receiving the first optical signal.

The central control node may be one or more of: a NMS; a transport controller; a SDN controller; a transport NMS; a radio controller; and a radio NMS.

In step 902, the method of FIG. 9 comprises configuring the PWSS to direct one or more wavelengths of an incoming WDM optical signal towards a corresponding one or more ports of a plurality of ports comprised in the PWSS based on the configuration information. Each of the one or more ports or each of the plurality of ports may be configured to be connected to a transceiver. The transceiver that is connected to a port may comprise a fixed-wavelength transmitter or a tunable-wavelength transmitter. The one or more ports may be comprised in the PWSS. Each of the plurality of ports may be an add port or a drop port. In some embodiments, the plurality of ports are tuneable-wavelength ports.

Each of the one or more wavelengths may be a central wavelength of a band of wavelengths. Configuring the PWSS to direct one or more wavelengths may comprise configuring the PWSS to direct one or more wavelength bands, where each wavelength band is defined by a central wavelength (or frequency) and a bandwidth.

In some embodiments, the configuration information may comprise a port allocation for each of a subset of the one or more wavelengths of an incoming WDM optical signal. In some of these embodiments, the step of configuring, 902, the PWSS is further based on an algorithm. The port allocation may specify a port to which the corresponding wavelength should be directed.

In some embodiments, the configuration information comprises a port allocation for each of the one or more wavelengths.

The one or more wavelengths may comprise: a set of downstream wavelengths from a component upstream of the remote node, wherein the downstream wavelengths are for carrying information that is intended for the remote node or for transporting information intended for a component downstream of the remote node

Alternatively, the one or more wavelengths may comprise: a set of upstream wavelengths from a component downstream of the remote node, wherein the upstream wavelengths are for carrying information that is intended for the remote node or for transporting information intended for a component upstream of the remote note.

In some embodiments, the incoming WDM optical signal comprises a first and second portion of wavelengths, and the first portion comprises the one or more wavelengths. In some of these embodiments, configuring the PWSS further comprises configuring the PWSS to transmit the second portion of wavelengths unmodified. The second portion of wavelengths may comprise one or more wavelengths.

The incoming WDM optical signal may be bidirectional.

In some embodiments, the method of FIG. 9 may further comprise, after configuring the PWSS, notifying the central control node that the PWSS has been configured.

In some embodiments, the method of FIG. 9 may further comprise, after configuring the PWSS, receiving the incoming WDM optical signal from the central control node.

In some embodiments, the method of FIG. 9 may further comprise, after configuring the PWSS, receiving, from the central control node, a second optical signal comprising updated configuration information; and reconfiguring the PWSS based on the updated configuration information

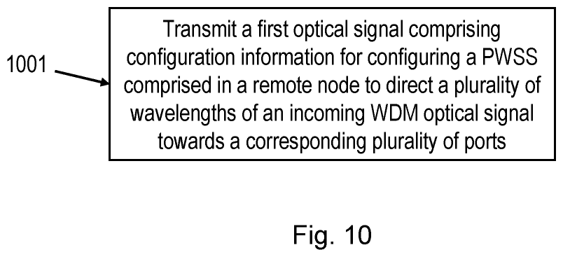

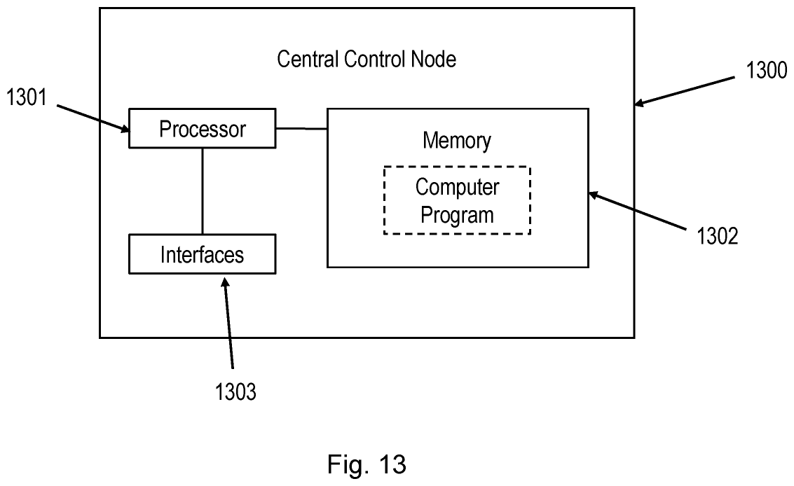

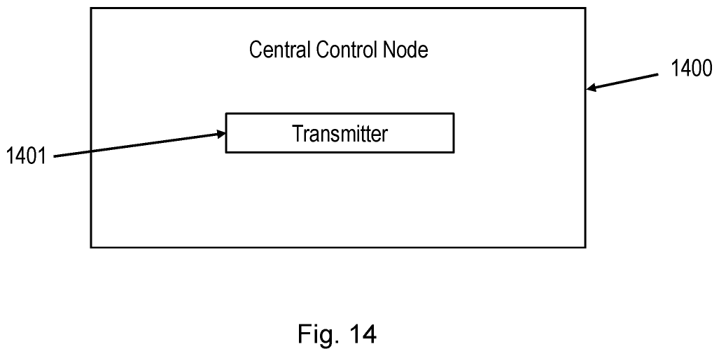

FIG. 10 is a flow chart showing a method performed by a central control node according to some embodiments. The central control nodes described with reference to FIG. 13 and FIG. 14 may perform the method of FIG. 10.

The central control node may be one or more of: a NMS; a transport controller; a SDN controller; a transport NMS; a radio controller; and a radio NMS.

In step 1001, the method of FIG. 10 comprises: transmitting, to a remote node, a first optical signal comprising configuration information for configuring a PWSS comprised in the remote network node to direct one or more wavelengths of an incoming WDM optical signal towards a corresponding one or more ports of a plurality of ports comprised in the PWSS. It should be understood that the WDM optical signal is ‘incoming’ from the point of view of the remote node. Each of the plurality of ports may be configured to be connected to a transceiver. The transceiver to which a port is connected may comprise a fixed-wavelength transmitter or a tunable-wavelength transmitter. Each of the plurality of ports may be an add port or a drop port. In some embodiments, the plurality of ports are tuneable-wavelength ports.

In some embodiments, the method of FIG. 10 may further comprise, prior to transmitting the first optical signal, receiving one or more of: an identifier for the PWSS; a serial number for the PWSS; a part number for the PWSS; a number of ports for the PWSS; and a total port capacity for the PWSS. The total port capacity may comprise active and inactive ports of the PWSS. Inactive ports are those not currently in use by the PWSS.

The configuration information may be transmitted: on a control channel; on a dedicated wavelength; and/or as an envelope modulation of the first optical signal. The configuration information may comprise one or more of: an identifier for the PWSS; an identifier for one or more of the plurality of ports; and an identifier for one or more of the one or more wavelengths. In some embodiments, the configuration information comprises a port allocation for each of a subset of the one or more wavelengths. In some embodiments, the configuration information comprises a port allocation for each of the one or more wavelengths.

The one or more wavelengths may comprise a set of downstream wavelengths from a component upstream of the remote node. The downstream wavelengths are for carrying information that is intended for the remote node or for collecting information intended for a component downstream of the remote node.

Alternatively, the one or more wavelengths may comprise a set of upstream wavelengths from a component downstream of the remote node. The upstream wavelengths are for carrying information that is intended for the remote node or for collecting information intended for a component upstream of the remote note.

In some embodiments, the incoming WDM optical signal comprises a first and second portion of wavelengths, and the first portion comprises the one or more wavelengths. In some of these embodiments, configuring the PWSS further comprises configuring the PWSS to transmit the second portion of wavelengths unmodified. The second portion of wavelengths may comprise one or more wavelengths.

The incoming WDM optical signal may be bidirectional. The remote node may be in chain topology or tree topology.

In some embodiments, the method of FIG. 10 further comprises, after transmitting the first optical signal, receiving a notification that the PWSS has been configured.

In some embodiments, the method further comprises transmitting, to the remote node, the incoming WDM optical signal.

In some embodiments, the method of FIG. 10 further comprises, after transmitting the first optical signal, transmitting, to the remote node, a second optical signal comprising updated configuration information.

FIG. 11 is a block diagram illustrating functional modules in a remote node comprising a PWSS according to some embodiments. The remote node 1100 comprises a processor 1101, interfaces 1103, and a memory 1102. Any one or more of the processor 1101, interfaces 1103, and memory 1102 may be comprised in a PWSS that is comprised in the remote node 1100.

FIG. 12 is a block diagram illustrating functional modules in a remote node 1200 comprising a PWSS according to some embodiments. The remote node of FIG. 12 comprises a receiver 1201 configured to receive, from a central control node, a first optical signal comprising configuration information.

The remote node further comprises a processor 1202 configured to configure the PWSS to direct one or more wavelengths of an incoming WDM optical signal towards a corresponding one or more ports of a plurality of ports comprised in the PWSS based on the configuration information.

One or both of the receiver 1201 and the processor 1202 may be comprised in the PWSS that is comprised in the remote node 1200.

FIG. 13 is a block diagram illustrating functional modules in a central control node according to some embodiments. The central control node 1300 comprises a processor 1301, interfaces 1303, and a memory 1302.

FIG. 14 is a block diagram illustrating functional modules in a central control node according to some embodiments. The central control node 1400 of FIG. 14 comprises a transmitter 1401 configured to transmit, to a remote node, a first optical signal comprising configuration information for configuring a PWSS comprised in the remote node to direct one or more wavelength channels of an incoming WDM optical signal towards a corresponding one or more ports of a plurality of ports comprised in the PWSS.

Use of a received optical signal to configure a PWSS, as described herein, simplifies inventory and reduces inventory costs. It also enables the initial configuration and subsequent changes to the wavelength plan to be performed remotely (e.g., away from the site of the PWSS/TRX antenna). As such, the number of visits to the site for installation, configuration and/or fault recovery are greatly reduced and remote changes to the PWSS configuration can be carried out throughout the network lifetime. Planning operations are simplified because it is not necessary to plan the assignment of the wavelengths at remote sites in advance. Furthermore, the wavelength assignment can be upgraded and/or modified dynamically and remotely, according to the needs at the corresponding site.

The techniques disclosed herein are compliant with any radio architecture, any transport architecture (e.g., software-defined networking architecture and/or network management architecture) and are future proofed for Open Radio Access Network (O-RAN). The techniques are also compliant with existing TRXs, including those that are tuneable in transmission. This compliance of the disclosed techniques will lead to widespread compatibility and higher production volumes of devices according to the present disclosure, thus resulting in an efficient use of resources.

Transmitting an optical signal to configure a PWSS, as described herein, enables the initial configuration and subsequent changes to the wavelength plan to be performed remotely from the central control node (away from the site of the PWSS/TRX antenna). This contrasts with existing methods in which a hardware change is required. As such, the number of visits to site for installation, configuration and/or fault recovery are greatly reduced and remote changes to the PWSS configuration can be carried out throughout the network lifetime. As noted above, planning operations are simplified because it is not necessary to plan the assignment of the wavelengths at remote sites in advance. Furthermore, the wavelength assignment can be upgraded and/or modified dynamically and remotely, according to the needs at the corresponding site.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that incorporates an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1.-69. (canceled)

70. A method performed by a remote node of a communication network, the method comprising:
receiving, from a central control node, a first optical signal comprising configuration information for a programmable wavelength-selective splitter (PWSS) of the remote node; and
based on the configuration information, configuring the PWSS to direct one or more wavelengths of an incoming wavelength-division multiplexed (WDM) optical signal towards corresponding one or more of a plurality of ports of the PWSS,
wherein the configuration information comprises one or more of the following: the identifier of the PWSS; an identifier of at least one of the plurality of ports; and an identifier of at least one of the one or more wavelengths.

71. The method of claim 70, wherein the configuration information comprises a port allocation for one of the following:
each wavelength of a subset of the one or more wavelengths; or
each wavelength of the one or more wavelengths.

72. The method of claim 71, wherein configuring the PWSS is further based on an add/drop wavelength allocation algorithm.

73. The method of claim 70, wherein one or more of the following applies:
each of the plurality of ports is configured to be connected to a transceiver; and
the one or more ports, towards which the one or more wavelengths of the incoming WDM optical signal are configured to be directed, are tuneable-wavelength ports

74. The method of claim 70, wherein the remote node is part of one of the following: a chain topology, a point-to-point topology, or a tree topology.

75. The method of claim 70, further comprising, after configuring the PWSS, notifying the central control node that the PWSS has been configured.

76. The method of claim 70, wherein the central control node is comprised in one or more of the following: a network management system (NMS); a transport controller; a software-defined networking (SDN) controller; a transport NMS; a radio controller; and a radio NMS.

77. The method of claim 70, further comprising, after configuring the PWSS, receiving the incoming WDM optical signal from the central control node.

78. The method of claim 70, further comprising:
after configuring the PWSS, receiving, from the central control node, a second optical signal comprising updated configuration information; and
reconfiguring the PWSS based on the updated configuration information.

79. A method performed by a central control node of a communication network, the method comprising:
receiving one or more of the following information related to a programmable wavelength-selective splitter (PWSS) of a remote node of the communication network: an identifier of the PWSS, a serial number of the PWSS, a part number of the PWSS, a number of ports for the PWSS, and a total port capacity for the PWSS; and
subsequently transmitting, to the remote node, a first optical signal comprising configuration information for configuring the PWSS to direct one or more wavelengths of an incoming wavelength-division multiplexed (WDM) optical signal towards a corresponding one or more of a plurality of ports of the PWSS.

80. The method of claim 79, wherein the configuration information comprises one or more of the following: the identifier of the PWSS; an identifier of at least one of the plurality of ports; and an identifier of at least one of the one or more wavelengths.

81. The method of claim 79, wherein the configuration information comprises a port allocation for one of the following:
each wavelength of a subset of the one or more wavelengths; or
each wavelength of the one or more wavelengths.

82. The method of claim 79, wherein one or more of the following applies:
each of the plurality of ports is configured to be connected to a transceiver; and
the one or more ports, towards which the one or more wavelengths of the incoming WDM optical signal are configured to be directed, are tuneable-wavelength ports

83. The method of claim 79, wherein the remote node is part of a chain topology or a tree topology.

84. The method of claim 79, further comprising, after transmitting the first optical signal, receiving a notification that the PWSS has been configured.

85. The method of claim 79, further comprising transmitting the incoming WDM optical signal to the remote node.

86. The method of claim 79, wherein the central control node is comprised in one or more of the following: a network management system (NMS); a transport controller; a software-defined networking (SDN) controller; a transport NMS; a radio controller; and a radio NMS.

87. The method of claim 79, further comprising, after transmitting the first optical signal, transmitting to the remote node a second optical signal comprising updated configuration information for configuring the PWSS.

88. A network node configured to operate as a remote node of a communication network, the network node comprising:
a programmable wavelength-selective splitter (PWSS);
a processor operably coupled to the PWSS; and
a memory including instructions executable by the processor, wherein execution of the instructions by the processor causes the network node to perform the method performed by the remote node in claim 70.

89. A network node configured to operate as a central control node of a communication network, the network node comprising:
a processor; and
a memory including instructions executable by the processor, wherein execution of the instructions by the processor causes the network node to perform the method performed by the central control node in claim 79.
